(19) United States
(12) Patent Application Publication
(10) Pub. No.: US 2004/0064733 A1
(43) Pub. Date: Apr. 1, 2004

(54) System and method for Concurrent Version Control and Information Management of files and documents sent as attachments through e-mail or web-mail

(75) Inventor: Li Gong, Santa Clara, CA (US)

Correspondence Address: LI GONG, 745 Nicholson Ave., Santa Clara, CA, 95051, US

(73) Assignee: JudoSoft Inc., Santa Clara, CA (US)

(21) Appl. No.: 10/606,550

(22) Filed: Jun. 26, 2003

Related U.S. Application Data
(60) Provisional application No. 60/393,546, filed on Jul. 5, 2002.

(51) Int. Cl. H04L 9/00

(52) U.S. Cl. 713/201

(57) ABSTRACT

An interactive information management system is provided to interact with e-mail systems by which information sent or received as attachment can be managed and shared dynamically among e-mail users. E-mail users can indicate rules on attachment and share information management with e-mail receivers in such a way that ensures data integrity and efficiency. The information management system uses Concurrent Version Control to manage the integrity of the content and may use a different connection channel other than the e-mail itself to transfer attachments. And the system provides both web-based information management interface and e-mail client plug-in interface for real-time attachment and related information management. The user of the system may use any e-mail clients and systems to interact with the information management system.

### CROSS-REFERENCE TO RELATED APPLICATIONS

Provisional patent application No. 60/393,546, confirmation No. 8023

### FEDERALLY SPONSORED RESEARCH

Not Applicable

### SEQUENCE LISTING OR PROGRAM

Not Applicable

### BACKGROUND

Various problems can arise when using e-mail attachments to send out information that needs constant update and modification.

One of the problems is lacking effective direct document management (version control. Edit, Delete, and etc.). Assume one user sends an original document as attachment to another user. The recipient then downloads the document, modifies it and sends the modified version back to the original sender. The original sender gets and modifies the document, and sends it back to the same recipient. This process may take many rounds. Soon, those two users may have sent the same file but with modifications to each other many times. Up to this point, each user has several versions of the same document as e-mail attachments. It is not only very confusing as to how to manage the modified attachments, but also causing potential document integrity and authenticity concerns among legitimate senders and receivers.

Another potential problem is e-mail storage issue. Each e-mail user gets a limited amount of storage space for storing e-mails, especially when using web-based e-mail applications, such as Yahoo mail or Hotmail. Sending one large document back and forth as attachment several times will quickly saturate allocated storage space. And users have to constantly clean up the mailbox by deleting entire e-mails. Other useful information can be lost during such a brutal clean-ups. An application is needed to allow user selectively delete attachments and leave other part of a e-mail untouched.

Furthermore, attachments are referred to or related to some particular project(s). Without effectively aggregating and managing the attachment information from both project and participant perspectives and link attachments directly to project(s), lots of useful information may be lost.

Based on the foregoing, there is clearly a need to allow users directly apply file management controls (Concurrent Version Control or other file management rules/commands, such as Edit, Delete, Link, Associate, etc.) on attachments in a manner that avoids said file and storage space management problems inherent in use of e-mail attachments.

### SUMMARY

Using an e-mail or web-mail client, a user can send out messages with attachment(s) in any formats. Instead of sending the attachment together with the mail message through conventional mail servers, through user specification or pre-defined properties, the attachment will be detached from the original mail message content and be stored into a local storage area of a special Project/Information Management Server (IMS) that can be installed inside or outside companies' firewalls. A unique attachment descriptor and locator will be generated to identify the saved attachment, and the original e-mail will include the newly created descriptor and locator in its message body and be sent to recipients through normal mail servers. The Information Management Server will apply Concurrent Version Control (CVS) and other file and document management rules/commands (such as Edit, Delete, Modify, Link, Associate, etc.) specified by the e-mail sender on the stored attachment files. Upon receiving the e-mail, the recipients can click the attachment locator link and obtained a version-controlled copy of the original attachment from the IMS. Recipients can modify the attachment in his/her local machine and check in the modified version as an attachment through e-mail or through provided Client Information Management Web Interface. All users having rights to access the attachments will receive e-mail notifications for any version or content update of a file. Permission to access the Client Information Management Web Interface will be administrated by the original e-mail creator or the group project organizer. IMS will manage and log all check-in, checkout and modification activities related to the attachment, and maintain one updated master copy. All previous versions will be compressed and stored until deletion. A user can admin all managed attachments through either e-mail or web-mail client, or Client Information Management Web Interface (login authentication is needed). Attachments can be managed under a specified project environment preemptively created by its organizer(s). A dynamic link of all projects (attachment related) to which a user subscribed will be conveniently displayed on e-mail or web-mail client interface as folders in addition to the Client Information Management Web Interface. The system allows direct e-mail attachment management.

### DRAWINGS

FIG. 1: System and Flow chart of conventional E-mail system

FIG. 2: System and Flow Chart of the claimed new system on how to apply file management controls on e-mail attachments

### DETAILED DESCRIPTION

### FIELD OF THE INVENTION

The present invention relates to techniques for directly managing e-mail attachments by applying Concurrent Version Control and other file management rules (such as Edit, Delete, Modify, Link, Associate, etc.) using either E-mail or Web-mail client interface, or web-based information management interface.

### BACKGROUND OF THE INVENTION

Various problems can arise when using e-mail attachments to send out information that needs continuous update and modification.

One of the problems is lacking effective direct document management (version control. Edit, Delete, and etc.). Assume one user sends an original document as attachment to another user. The recipient then downloads the document, modifies it and sends the modified version back to the original sender. The original sender gets and modifies the document, and sends it back to the same recipient. This process may take many rounds. Soon, those two users may have sent the same file but with modifications to each other many times. Up to this point, each user has several versions of the same document as e-mail attachments. It is not only very confusing as to how to manage the modified attachments, but also causing potential document integrity and authenticity concerns among legitimate senders and receivers.

Another potential problem is e-mail storage issue. Each e-mail user gets a limited amount of storage space for storing e-mails, especially when using web-based e-mail applications, such as Yahoo mail or Hotmail. Sending one large document back and forth as attachment several times will quickly saturate allocated storage space. And users have to constantly clean up the mailbox by deleting entire e-mails. Other useful information can be lost during such a brutal clean-ups. An application is needed to allow user selectively delete attachments and leave other part of a e-mail untouched.

Furthermore, attachments are referred to or related to some particular project(s). Without effectively aggregating and managing the attachment information from both project and participant perspectives and link attachments directly to project(s), lots of useful information may be lost.

Based on the foregoing, there is clearly a need to allow users directly apply file management controls (Concurrent Version Control or other file management rules/commands) on attachments in a manner that avoids said file and storage space management problems inherent in use of e-mail attachments.

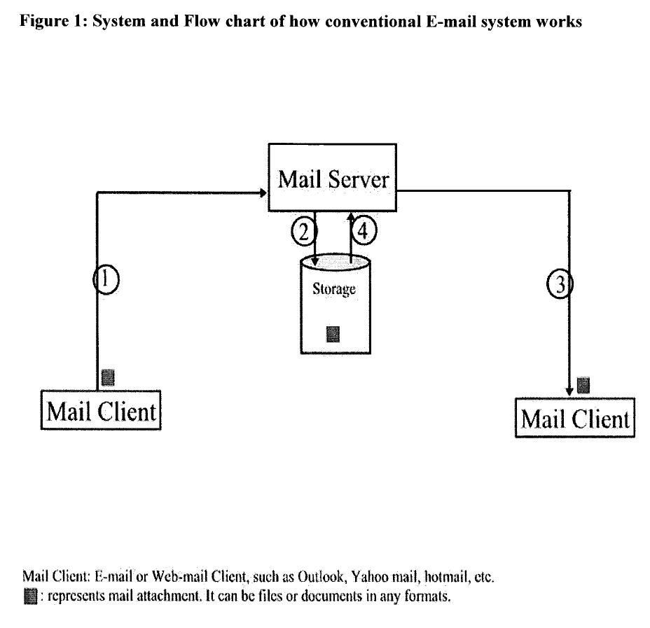

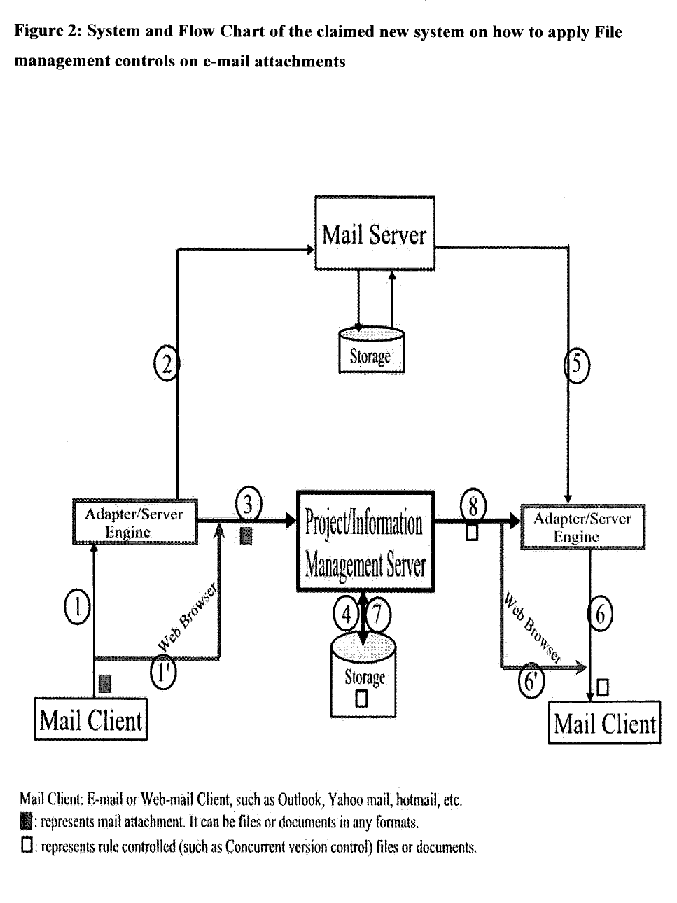

In order to demonstrate the benefits of the new system and method, it is necessary to show the difference between conventional e-mail system and the new system, and find out what are some of the difference by directly managing attachments. FIG. 1 is the system and flow chart of conventional e-mail system. FIG. 2 is the claimed new system and method for managing e-mail attachments directly.

Conventional E-Mail System Process (see FIG. 1):

1, Mail client sends a message with attachment to a recipient.

2, Recipient Mail Server receives the message and store the attachment in recipient mail storage space.

3, Recipient gets the message and sends request to download the attachment.

4, the Mail server loads the attachment from the storage and passes it back to recipient's local machine.

There are three problems:

If recipient modifies the attachment and sends back to the sender and so forth, it is difficult to make the modification synchronized, especially when more than two people involved

Many mail applications leave copies of mails on server. So every time a modified attachment created, a copy will be stored on server, and pretty soon, it will eat up all storage space on the mail server.

Users have to delete an entire e-mail in order to clean up the e-mail storage space.

How the Claimed New System and Method for Managing Attachments Work (See FIG. 2):

1, user sends e-mails with attachments through e-mail client interface (Outlook, etc.) or web browser based web-mail client interface (Hotmail, etc.). There are two ways for users to specify any special file treatment rules on attached documents: by selecting from rule control feature list (this list may include features such as Concurrent Version Control etc.) that is directly linkable to the attached file names; or by sending or replying messages under special project folders that are created automatically each time user creates a new project.

1′, Users can access the Client Project/Information Management Web Interface to manage attachment information (login authentication is needed).

2, The Adapter/Server Engine will process the e-mail and check whether the attachment is subjected to Concurrent Version Control or other specific rules or not: if yes, the attachment will be separated from the message body and a unique attachment locator and descriptor will be generated, passed along with the original message and be processed by the Mail Server; if not, all information is passed and processed by the Mail Server as in ordinary situations.

3, Adapter/Server Engine passes the attachment files or documents along with identification information (descriptor and locator) to Project/Information Management Server.

4, The Project/Information Management Server will apply concurrent version control and other document management methods/rules, such as Edit, Delete, Modify, Link etc., to the document and store it in a structured environment. Users can access and change the environment setting by login through Client Information Management Web Interface.

5, Mail Server sends the message to recipients' Adapter Engine. The Adapter Engine will judge whether the attachment is a virtual link (descriptor and locator information only) or not. If it is not subjected to any version control or file management commands/rules, the Adapter Engine will simply serve as a mail proxy serve and relay the message to the recipient; if it is subjected to some kind of version control or file management commands/rules, the Adapter Engine will help retrieve and manage information (file or document) per user request;

6, Recipient gets the message and requires downloading the attached file(s).

6′, Recipient(s) can access the attachment(s) directly through Client information Management Web Interface (login authentication needed). Under each client domain, as long as the owner of the original document (or project) permits modification by that client, all information related to that document (or project) is manageable and changeable.

7, Adapter/Server Engine will handle the download request and get a controlled version of the master attachment files from the Project/Information Management Server.

8, The Project/Information Management Server will pass the version controlled file(s) back to Adapter Engine, then to recipient local machine. The recipient can modify the file(s) in his/her local machine and check in the modified version through e-mail or through Client Information Management Web Interface. The Information Management server will store one master copy of the original file(s), and all modification will be checked against the master version and get updated. This ensures data integrity and less file storage space needed. It also opens up ways to manage e-mail attachment information directly into a leverage-able and share-able environment.

What I claim as my invention is:

1. A system comprises any e-mail or web-mail clients, one or more Adapter/Server Engines for processing e-mail attachment requests, one or more Conventional Mail Servers, and one or more Project/Information Management Servers for applying concurrent version control and other file management rules on stored attachments. These components are connected to each other as indicated in FIG. 2.

2. The system of claim 1 wherein e-mail or web-mail clients can be any standalone e-mail clients such as Outlook etc., and any web based e-mail clients, such as Yahoo mail, Hotmail etc.

3. The system of claim 1 wherein Conventional Mail Servers can be any mail servers that handle e-mail sending, receiving, and storage etc.

4. The system of claim 1 wherein Adapter/Server Engines are programs that process e-mails, identify rule controls on attachments according to user specification and predefined rules, and establish communications among mail clients and the Project/Information Management Server. The Adapter/Server engine will separate the attachment from the original e-mail, create a unique descriptor and locator and attach them to the original e-mail and pass the mail to conventional mail servers, meanwhile, the separated attachment along with other attachment identification information will be passed to Project/Information management Server(s). There can be more than one Adapter/server Engines depending on whether all e-mail correspondents are within the same network or not. If they are in the same network, only one Adapter/Server Engine is needed. And Adapter/Server Engine may not be needed for some recipients. If so, a browser based communication/access will be established when clicking the attachment link.

5. The system of claim 1 wherein Project/Information Management Server(s) is server side program that handles all detailed file and document management which includes store, retrieve, compare, update, delete, personalized attachment management, concurrent version control (on or off), etc. The said server has special storage management and profile management, and can be accessed via Internet browsers with secure authentication process and can be installed inside or outside firewalls.

6. A method of providing a secure and unique way to directly manage attachments among senders and receivers using either their e-mail or web-mail client interfaces or a browser based Project/Information Management Client Interface that requires login authentication, the method comprising following steps:
A sender attaches attachment(s) in an e-mail that will be sent to recipient(s). After attaching the attachment to the e-mail, the sender selects attachment control rules either from a list of features that can be directly linked to individual attachment, or from specifying a set of preemptive rules that apply to any attachments sent or received under certain project folder(s) other than the Inbox;
The said Adapter/Server Engine intercepts the sent e-mail and processes it to judge whether rules should be applied to the e-mail or not. If it finds out that special rules, such as concurrent version control, are present, the said Adapter/Sever engine will generate a unique locator and descriptor for the e-mail attachment, separate the attachment form the original e-mail, and include the locator and descriptor in the original e-mail. The newly modified e-mail will be passed to conventional mail server and delivered to mail recipient(s). The intercepted attachment along with its descriptor, locator and applied rules will be passed to Project/Information Management Server via unique messaging protocol;
The said Project/Information Management Server gets the attachment package, processes applied rules, creates a management environment according to the rules, and applies special document management method such as Concurrent Version Control on the attachment. The said server allows users modify settings on an attachment through authenticated browse based Client Interface. Such an interface will be administrated by an agreed upon owner of the project or the original attachment creator. The member list of the project and their accessing right can be from original recipient e-mails and later be added or deleted by the project owner.
The recipients' Adapter/Server Engine gets the e-mail first and basing on the locator information, establishes a universal locator link within the e-mail ready to broker between mail client and the Project/Information Management Server and passes the e-mail to recipient(s). If the recipient network does not have an Adapter/Server Engine installed, the recipient will get the e-mail with an attachment link. Click on the link will launch a browser window that allows direct secure communication to Project/Information Management Server and download the attachment.
When recipient(s) receives the e-mail with attachment description and locator link, he/she can request (download) to receive a version-controlled copy of the original attachment by clicking the locator link of the attachment. The request will be sent to the Project/Information Management Server;
The said Project/Information Management Server gets the request, check whatever rules apply, for example Concurrent version Control, to the requested document and creates a copied version of the master document. The downloaded document will have version control etc. information attached to it;
When recipient(s) gets the documents, finishes modify it and want to sent it back. He/she can either reply to the original e-mail. Since the version control and identification information are hidden in the original e-mail, as along as users make modification directly on the downloaded file(s), there is no need to specify rules unless user wants to apply different management rules on the said attachment, such as taking out the version control on the document. However, only the document creator will be able to do so. Others can add additional rules only when owner of the file allows them to do so;
The said Adapter/Server Engine on the recipient side intercepts the e-mail and checks the embedded rules with the attached documents. It will pass the change requests along with the attachment to the Project/Information Manager Server. Meanwhile a descriptor and locator will be created and included with the original e-mail. The e-mail is handled by mail servers and sent to recipients;
The Project/Information Management Server will update the document according to the requests and keep one updated master file and log changes;
When recipient gets the attachment file by clicking the attachment link, the document will be the latest updated version.

7. The method of claim 6 wherein the step of specifying rules on the attachment from a mail client comprises the step of creating a list of selectable rules that can be directly linked to an attachment for selection or creating a special mail folder other than the Inbox with special environment settings that apply to all mails sent or received in the folder. Such folders and list of selectable rules displayed on the mail client interfaces will be managed through the said Adapter/Server Engine. And users can pre-define rules into a folder environment through the web browser based Client Information Management Interface or create a folder while attaching and applying rules on the attachment(s). Folder information will be automatically updated into each participant's mail client interface as project folders (inside, it has links to every attachment belonging to the project) when connection is established between client e-mail interface and the IMS.

8. The method of claim 6, wherein the step of accessing managed attachments from a mail client interface other than the Client Information Management Interface comprises special project folders that have dynamic links to attachment(s) belong to each specified project. Accessing the project and management information from the mail client interface does not need additional authentication. The information exchanges are brokered by the Adapter/Server Engine, and then connect to the Information Management Server(s). The program can also automatically launch a browser management console for each project and attachment per use request. And any new project information created through either the Client Information Management Interface or the mail client (sending an attachment with rules will automatically create a new project if such a step has not been done) will be automatically updated into mail client as folder(s). The information exchanges thereafter will be directly handled by Information Management Server (IMS).

9. The method of claim 6, wherein the step of providing an authentication includes verifying the identity of the requesters. Attachment(s) can be managed under a special group project. The project, including participants' identities and accessing rights, can be created through the Project/Information Management Client Interface before or after a rule controlled attachment being sent.

10. The method of claim 6, wherein in the step of file/document management through Project/Information management Server, all group members or recipients (including sender) will share one master copy of the original document. Rules that are applied to the document(s) can be added and deleted by owner(s) of the document(s) through either the mail client or the web based Client Information Management Interface. Users that have account on the Project/Information Management Server will get an individualized client interface based on his/her own profile. Whenever a new project is created with a user as a member, the project information will automatically added to his/her own client interface for management and reference. If the user does not have a account with the Project/Information Management Server but is a member of a project, when he/she requests information from the Information Management Server, the server will authenticate the user and automatically launch a browser based client interface for accessing the project related information.

11. A method of displaying, synchronizing, and communicating information management between Project/Information Management Server and various mail clients through Adapter/Server Engine, the method comprises the steps:
A user logins to Project/Information Management Server and create a project specifying members, members' e-mail addresses, document control default settings (such as Concurrent Version Control etc.), etc.;
A notification of the newly created project will be sent to each member by e-mail. Upon accepting the e-mail invitation by replying on it, the said Adapter/Server Engine will create a new folder in the client mail interface with the project name as the folder name. Under the folder, user will be able to find links to all information related to the project. Click on those links will automatically bring up a web browser with the project related information. The browser will communicate directly with the Project/Information Management Server.
Under the newly created folder, user can send and receive messages related to the project. The default setting of rules will be applied to all attachments under this folder unless otherwise specified by users. All communication and synchronization between mail clients and the Project/Information Management Server are handled by the Adapter/Server Engine;
If the user does not install the Adapter/Server Engine on his local network, click on the attachment link will directly establish a communication between the mail client and the Project/Information Management Server through a web browser. The attachment will be downloaded from the said Information Management Server. The user can access the project related information through the browser based Client Information Management Interface. For such a user, all modified documents have to be check-in through the browser interface instead of e-mail. Or
A user can send e-mails with rules applied to the attachment(s) before creating a project in the Project/Information Management Server. The Adapter/Server Engine will intercept the attachment along with recipient addresses, identification, and control information to the said Information Management Server. The Information Management server then creates a new project with those available information. The user can later perfect the project through Client Information Management Interface. Rest of the communication processes will be the same as that of creating the initial project.
